(19) United States
(12) Patent Application Publication
(10) Pub. No.: US 2009/0238537 A1
(43) Pub. Date: Sep. 24, 2009

(54) VIDEO RECORDING APPOINTMENT SYSTEM, AND DISPLAY DEVICE

(75) Inventor: KOSUKE KINOSHITA, Osaka (JP)

Correspondence Address: PILLSBURY WINTHROP SHAW PITTMAN, LLP, P.O. BOX 10500, MCLEAN, VA, 22102, US

(73) Assignee: Funai Electric Co., Ltd., Osaka (JP)

(21) Appl. No.: 12/405,511

(22) Filed: Mar. 17, 2009

(30) Foreign Application Priority Data
Mar. 19, 2008 (JP) 2008-070634

(51) Int. Cl. H04N 5/91; H04N 5/66

(52) U.S. Cl. 386/83; 348/739; 348/E05.133

(57) ABSTRACT

A video recording appointment system includes a plurality of video recording devices and a display device. The display devices is connected to the plurality of video recording devices by corresponding cables. When the display device receives a remote control signal related to video recording appointment, it queries the plurality of video recording devices, via the cables, as to whether or not they have antennas connected to them. Upon receipt of this query, each of the plurality of video recording devices checks whether or not it is connected to an antenna. And each of the plurality of video recording devices returns the result of this checking to the display device via its corresponding cable. Then the display device displays device specification information upon its screen on the basis of these check results which have been returned.

### CROSS REFERENCE

This Nonprovisional application claims priority under 35 U.S.C. § 119(a) on Patent Application No. 2008-070634 filed in Japan on Mar. 19, 2008 the entire contents of which are hereby incorporated by reference.

### BACKGROUND OF THE INVENTION

The present invention relates to a video recording appointment system in which a video recording device and a display device are connected together via a bidirectional cable, and in which setting of video recording appointments for the video recording device is performed from the side of the display device, and to a display device which may be applied to this video recording appointment system.

From the prior art, a video recording appointment system has been widely known in which a video recording device and a display device are mutually connected together via a bidirectional cable. Such a video recording device may be, for example, a DVD recorder or a Blu-ray recorder. Furthermore, the display device may be, for example, a liquid crystal television or a plasma television. And the bidirectional type cable may be, for example, an HDMI (High Definition Multimedia Interface) cable. In the following, a video recording appointment system which is connected together with HDMI cables will be explained.

In this video recording appointment system a CEC (Consumer Electronic Control) function is implemented, which makes it possible to control any one of the devices which are connected together with HDMI cables by remote control, using any other one of the devices. For example, with this CEC function, when the user presses the replay key of a DVD recorder, the power supply to a television can be turned on at the same time; and it is also possible to make the settings for appointment of a video recording by the DVD recorder from the side of the television.

Due to this, with this type of video recording appointment system, the user does not need to have a remote control for the video recording device, but can make the settings for video recording appointment upon the video recording device from the side of the display device. For example, the user may input, to a TV, a video recording appointment for a DVD recorder, in order to perform recording of a television program which will be broadcast on Channel 101 from 8 pm on 3 May.

When a video recording appointment is set up on a display device, the display device transmits the details of this video recording appointment to the video recording device via the HDMI cable. And the video recording device performs video recording on the basis of the details in this video recording appointment. It should be understood that, in Japanese Laid-Open Patent Publication 2007-274296, there is proposed a replay device that detects whether or not a display device is in a state to receive a signal which is outputted from the replay device.

However, with the prior art video recording appointment system described above, the display device is not able to ascertain whether or not any antenna is connected to the video recording device. Moreover, after having transmitted the details of the video recording appointment to the video recording device, the display device leaves the video recording process to the video recording device. In other words, the display device does not monitor the video recording operation of the video recording device.

Moreover, in recent years, the number of input ports provided to a display device has been increasing, and the number of video recording devices which can be connected to the same display device has been growing. Due to this, sometimes the case occurs that the user mistakenly makes a setting for video recording appointment for a display device to which no antenna is connected.

Accordingly, with a prior art video recording appointment system, it sometimes happens that video recording is not possible, even though the user has set a video recording appointment upon the display device. Thus such a prior art video recording appointment system may be considered as imperfect, since, although appointment of a video recording has become easy and convenient, actually it may be the case that it is not possible to perform the video recording. Due to this, the convenience of use for the user has been bad.

The object of the present invention is to provide a video recording appointment system, and a display device, with which failure of video recording performed on the basis of a video recording appointment from the side of the display device can be prevented, and with which the convenience of use for the user is enhanced.

### SUMMARY OF THE INVENTION

The video recording appointment system according to the present invention includes a plurality of video recording devices and a display device. In this structure, each of the video recording devices may be, for example, a DVD recorder, a Blu-ray recorder, or a hard disk recorder. Moreover the display device may be, for example, a liquid crystal television or a plasma television. And bidirectional type cables which connect the devices together may be, for example, HDMI (High Definition Multimedia Interface) cables. The display device is connected to each of the plurality of video recording devices via its own individual cable.

The display device receives a remote control signal related to a video recording appointment, and then queries each of the plurality of video recording devices, via its corresponding cable, as to whether or not an antenna is connected to that video recording device. With this structure, the user is able to input the details of the video recording appointment to the display device from its remote control device.

Upon receipt of the above query, each of the plurality of video recording devices checks whether or not it is connected to an antenna. And each of the plurality of video recording devices returns the result of this checking via its cable to the display device.

On the basis of these check results which have been returned, the display device displays device specification information upon its screen. This device specification information is information which specifies at least one of the video recording devices, to which no antenna is connected. The user looks at this device specification information, and can thereby ascertain whether or not the video recording device with which he wishes to perform video recording is connected to an antenna.

### BRIEF DESCRIPTION OF THE DRAWINGS

FIG. 1 is a system structural diagram of an video recording appointment system according to an embodiment of the present invention;

FIG. 2 is a block diagram of the main structure of an optical disk device included in the above described video recording appointment system;

FIG. 3 is a block diagram of the main structure of a television receiver included in the above described video recording appointment system;

FIG. 4 is a flow chart showing certain operations performed by a control unit of this television receiver;

FIG. 5 is a figure showing an example of a display provided upon this television receiver; and

FIG. 6 is a figure showing another example of a display provided upon this television receiver.

### DETAILED DESCRIPTION OF THE INVENTION

In the following, a video recording appointment system according to an embodiment of the present invention will be explained.

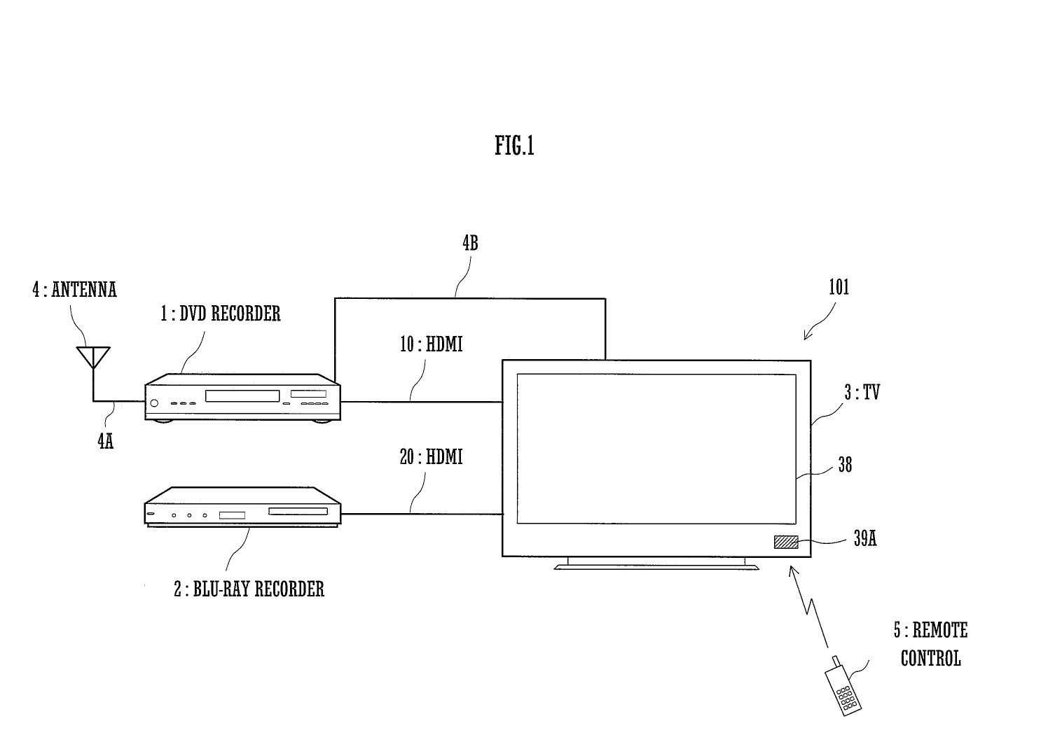

FIG. 1 is a system structural diagram of an video recording appointment system which is an embodiment of the present invention. This video recording appointment system 101 comprises a DVD recorder 1, a Blu-ray recorder 2, and HDMI (High Definition Multimedia Interface) cables 10 and 20 which respectively connect the DVD recorder 1 and the Blu-ray recorder 2 to a television receiver 3 (hereinafter termed the “TV 3”).

The DVD recorder 1 video records, onto a DVD disk, program data of a television program which has been received with an antenna 4 connected to the DVD recorder 1. Moreover, the DVD recorder 1 reads the program data from this DVD and outputs it to the exterior. Furthermore, the DVD recorder 1 outputs to the TV 3, via a cable 4B, the program data of the television program received with the antenna 4 connected to the DVD recorder 1.

The Blu-ray recorder 2 video records, onto a Blu-ray disk, program data of a television program which has been received with an antenna connected to the Blu-ray recorder 2. Moreover, the Blu-ray recorder 2 reads the program data from this Blu-ray disk and outputs it to the exterior.

Yet further, the TV 3 comprises a display unit 38 which processes program data outputted by either the DVD recorder 1 or the Blu-ray recorder 2 and displays a video image upon a screen, and a light reception unit 39A which receives a signal transmitted from a remote control 5 which receives input for video recording appointment.

This video recording appointment system 101 is endowed with a CEC (Consumer Electronic Control) function of it being possible to control these devices which are connected together via the HDMI cables, by the TV 3 and the remote control 5 operating together. For example, according to this CEC function, the user is enabled, when he presses the replay key of the remote control which corresponds to the DVD recorder 1, to turn on the power supply to the TV 3 at the same time, and he is also enabled to make a setting for video recording appointment on the DVD recorder 1 or the Blu-ray recorder 2 from the side of the TV 3.

Now the structure of the DVD recorder 1 will be explained, as being representative of a video recording device.

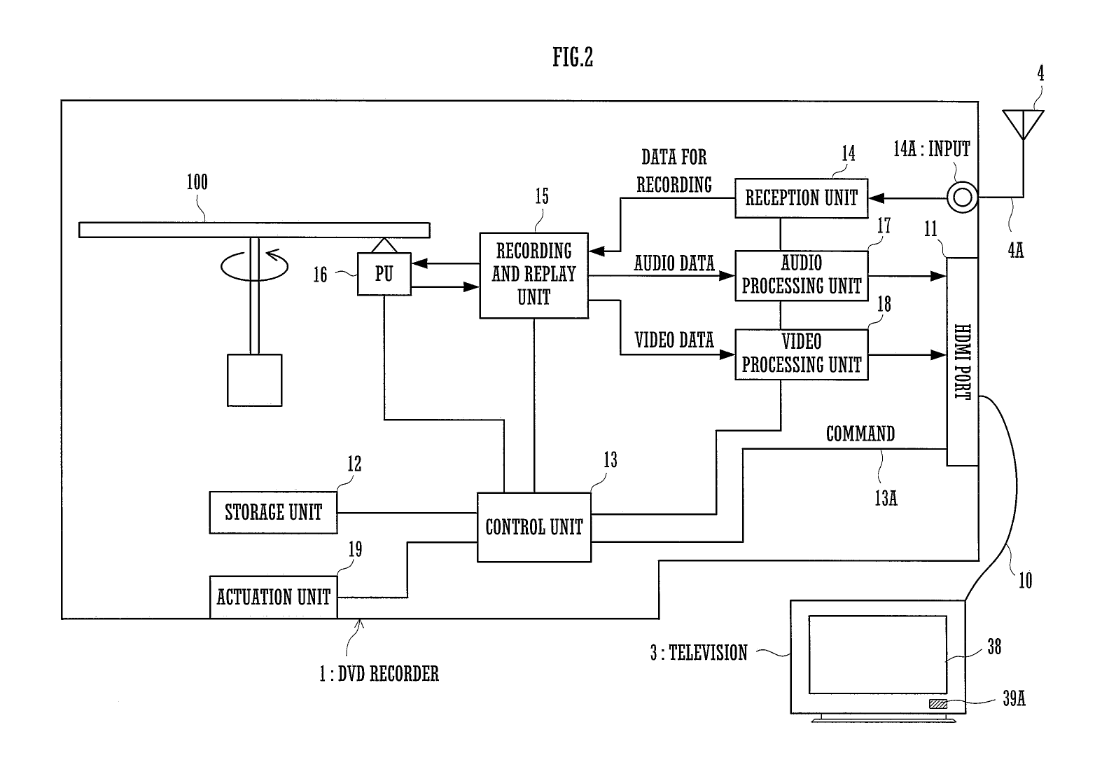

FIG. 2 is a block diagram showing the main structure of this DVD recorder of the video recording appointment system 1 according to an embodiment of the present invention. This DVD recorder comprises a reception unit 14, a recording and replay unit 23, a pickup head 16 (hereinafter termed the “PU head 16”), a replay unit 15, an audio processing unit 17, a video processing unit 18, a HDMI port 11, an actuation unit 19, a storage unit 12, and a control unit 13.

Furthermore, this DVD recorder 1 is connected to the television 3 via the HDMI cable 10 which is inserted into the HDMI port 11. The television 3 is a liquid crystal television which is compliant with the HDMI standard.

HDMI is an interface for transmitting a digital AV signal from a replay device to a display device such as a television receiver or the like.

With HDMI, via a DDC (Display Date Channel), it is possible to read in EDID (Extended Display Identification Data) which specifies the resolution and so on of a video signal which can be displayed by the DVD recorder 1 upon the television 3.

Furthermore, the storage unit 12 may, for example, consist of a flash memory. This storage unit 12 stores a control program in which is described a control method for controlling the operation of the various sections of the television 3.

The control unit 13 may, for example, consist of a microcomputer. This control unit 13 has a RAM (not shown in the figures) which serves as a working area for holding data which is being processed by the control program described above. Moreover, via a control line 13A for transmitting control signals (commands), the control unit 13 is connected to the HDMI port 11.

It should be understood that the control unit 13 corresponds to the “response means” in the Claims of this application.

The PU head 16 comprises a laser diode, a collimator lens, a beam splitter, an objective lens, a photodetector, a thread motor, and a two shaft actuator.

First, the structure of those elements which perform video recording operation will be described in detail.

The reception unit 14 may consist, for example, of a digital tuner. On the basis of a command from the control unit 13, this reception unit 14 receives (i.e. extracts), from the television broadcast signals received by the antenna 4, a television broadcast signal which is broadcast upon a selected channel. Moreover, the reception unit 14 demodulates this television broadcast signal into a transport stream, which is digital data, and outputs this stream to the recording and replay unit 15. This transport stream includes packet groups in which contents data which yields the television program is described, packet groups in which EPG data which specifies broadcast schedules for television programs on all channels is described, and so on. Here, the contents data may be, for example, encoded by MPEG.

The recording and replay unit 15 includes a buffer memory (not shown in the figures) for accumulating a plurality of packets. The recording and replay unit 15 extracts the contents data from the transport stream which has been inputted, and encodes this contents data. And the recording and replay unit 15 outputs this encoded digital signal to the PU head 16.

When this digital signal is inputted from the recording and replay unit 15, the PU head 16 regulates laser light of recording power according to this digital signal, and irradiates it onto the recording surface of a DVD 100. Due to this, this DVD recorder 1 video records the program data of the television program upon the DVD 100.

Next, the structure of those elements which perform replay operation will be described.

The PU head 16 irradiates laser light of read power onto the DVD 100, and detects the light which is reflected from the DVD 100 with a photodetector. Due to this, the information which is recorded upon the DVD 100 is read out optically.

The recording and replay unit 15 generates an RF signal on the basis of the output from a plurality of light reception elements which are included in the PU head 16, and amplifies this RF signal. And the recording and replay unit 15 processes this RF signal and extracts the data for video and audio therefrom, and decodes both of these. Here, the extracted video data may be, for example, encoded by MPEG. And the extracted audio data may be, for example, encoded by MPEG or AC3. And the recording and replay unit 15 outputs the audio data to the audio processing unit 17 and the video data to the video processing unit 18, while maintaining synchronization between both these data streams.

The audio processing unit 17 outputs the decoded audio data to the external television 3 as a digital audio replay signal. And the video processing unit 18 outputs the decoded video data to the external television 3 as a digital video replay signal.

The audio processing unit 17 and the video processing unit 18 are connected to the television 3 via the HDMI cable 10, which is inserted into the HDMI port 11. And the audio processing unit 17 and the video processing unit 18 transmit the digital signals described above to the television 3 via the HDMI cable 10 by the TMDS (Transition Minimized Differential Signaling) method.

It should be understood that the Blu-ray recorder 2 has a similar structure to that of the DVD recorder 1 shown in FIG. 2. And, in a similar manner, the Blu-ray recorder 2 is connected to the television 3 via the HDMI cable 20.

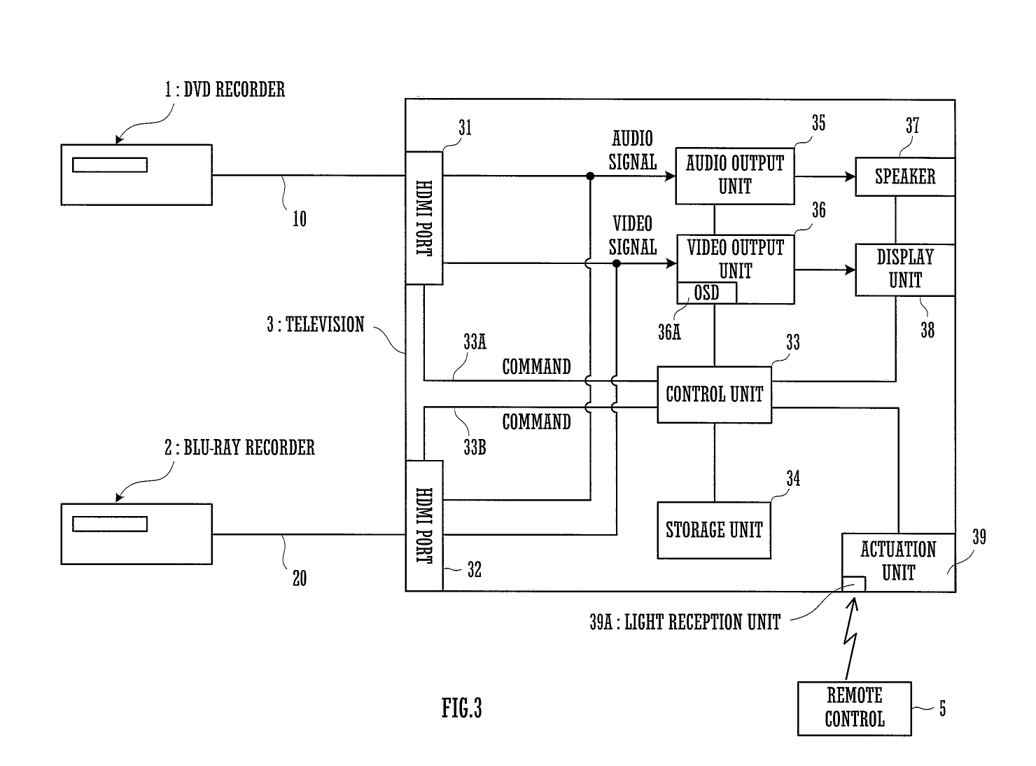

FIG. 3 is a block diagram showing the main structure of the television receiver 3 of this video recording appointment system according to an embodiment of the present invention. This television 3 is a so called liquid crystal television. The television 3 comprises a HDMI port 31 into which the HDMI cable 10 is inserted, a HDMI port 32 into which the HDMI cable 20 is inserted, an audio output unit 35, a video output unit 36, a speaker 37, a display unit 38, an actuation unit 39, a storage unit 34, and a control unit 33.

When the HDMI port 31 receives video data and audio data via the HDMI cable 10, it transmits the video data to the video output unit 36 and the audio data to the audio output unit 35. In a similar manner, when the other HDMI port 32 receives video data and audio data via the other HDMI cable 20, it transmits the video data to the video output unit 36 and the audio data to the audio output unit 35.

The audio output unit 35 D/A converts the digital audio data, amplifies the result, and outputs the final result to the speaker 37.

And the video output unit 36 includes an OSD memory 36A which stores data for OSD (On Screen Display) which consists of characters or illustrations or the like. On the basis of a command from the control unit 33, the video output unit 36 combines an image which is based upon the video data, and the OSD which is stored in the OSD memory 36A. And the image synthesis unit 6 D/A converts the resulting combined video data, and outputs the result to the display unit 38. Or, if no OSD is to be provided, then, without the above described combination process being performed, the image synthesis unit 6 directly D/A converts the video data transmitted from either one of the HDMI ports 31 and 32, and outputs the result to the display unit 38. The speaker 37 processes the analog audio replay signal which has been inputted thereto and emits sound. And the display unit 38 processes the analog video replay signal which has been inputted thereto and displays a moving image.

The user is accordingly able to view an image on the basis of the video replay signal which has been outputted from the DVD recorder 1, and to listen to audio on the basis of the replay audio signal which has been outputted from the DVD recorder 1. The storage unit 34 may, for example, consist of a flash memory. This storage unit 34 stores a control program in which is described a control method for controlling the operations of the various sections of the television 3.

The control unit 33 may, for example, consist of a microcomputer. This control unit 33 includes a RAM (not shown in the figures) which serves as a working space for holding data which is being processed by the above described control program. Moreover, the control unit 33 is connected to the HDMI port 31 via a control line 33A for transmitting commands. Due to this, the control unit 33 can perform exchange of commands with the control units of devices which are connected to this TV 3.

The actuation unit 39 is provided with a light reception unit 39A which receives actuation signals transmitted from the remote control 5 by infrared light. A plurality of keys is provided to the remote control unit 5, and an actuation signal is transmitted according to the key which is depressed. This plurality of keys may include, for example, a video recording appointment key which receives input for making a video recording appointment.

With the video recording appointment system 101 described above, the user is able to perform setting of a video recording appointment for the DVD recorder 1 upon the TV 3, without putting down the remote control 5 and picking up the remote control of the DVD recorder 1. And similarly, with this video recording appointment system 101, the user is able to perform setting of a video recording appointment for the Blu-ray recorder 2 upon the TV 3, without putting down the remote control 5 and picking up the remote control of the Blu-ray recorder 2. For example, the user may set, upon the TV 3, a video recording appointment to perform video recording with the DVD recorder 1 of a television program which is to be broadcast on Channel 101 from 8 pm on 3 May.

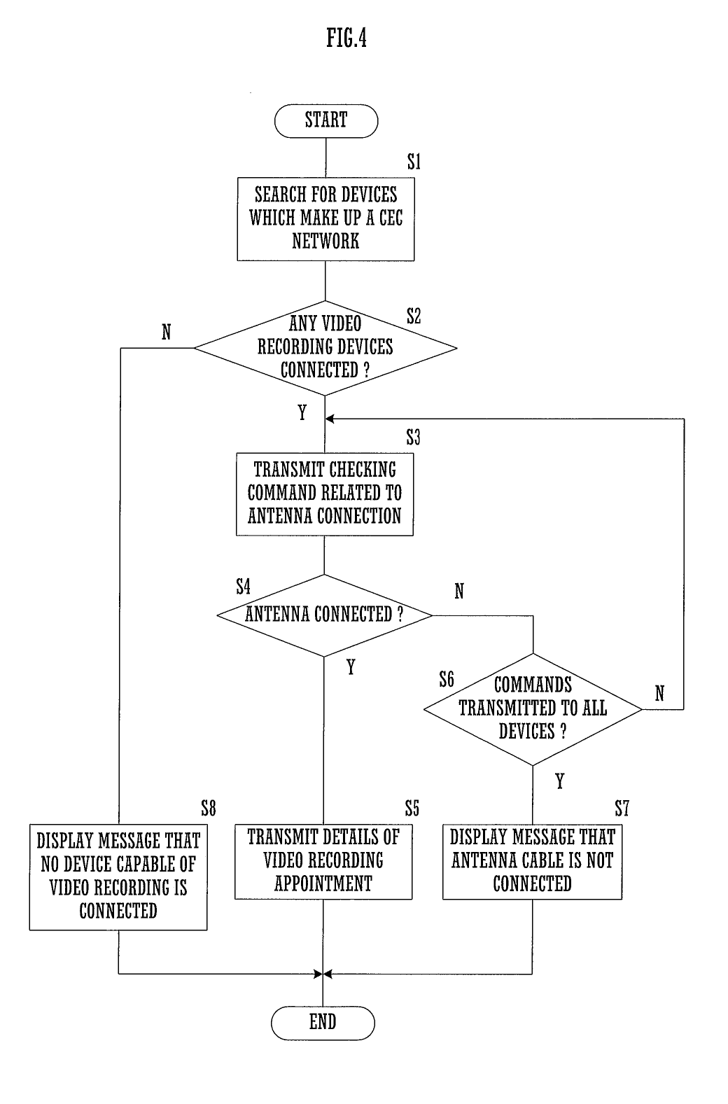

FIG. 4 is a flow chart showing certain operations performed by the control unit of this television receiver of the video recording appointment system according to an embodiment of the present invention. These operations are performed when the user actuates the video recording appointment keys and inputs a video recording appointment to the TV 3.

When the input of a video recording appointment is completed, the control unit 33 searches for devices which make up a CEC network (a step S1). This search uses a “Polling Message” command as defined by the HDMI-CEC standard, and is performed by checking for devices whose logical addresses have values from 1 through 14. Since, in this embodiment, the DVD recorder 1, the Blu-ray recorder 2, and the TV 3 make up a CEC network, accordingly ACKs are returned from both the DVD recorder 1 and the Blu-ray recorder 2, thus showing that they are both connected to the network. Due to this, the TV 3 is able to acquire the logical addresses of the devices which are connected. These logical addresses are information items which specify the types of the devices. Thus these logical addresses may specify replay devices such as, for example, a DVD player or a Blu-ray player or the like, or video recording devices such as a Blu-ray recorder or a hard disk recorder or the like.

Next, the control unit 33 makes a decision as to whether or not any video recording devices are connected, on the basis of the logical addresses which have been returned (a step S2). For example, if “Playback Device #1”, “Playback Device #2”, and “Playback Device #3” are returned as the logical addresses, then the result of this decision is negative. Conversely, if any one or more of “Recording Device #1”, “Recording Device #2”, or “Recording Device #3” is returned as one of the logical addresses, then the result of this decision is affirmative.

If it has been decided that some video recording device is connected (in the example of FIG. 1, the DVD recorder 1 and the Blu-ray recorder 2 will be found), then the control unit 33 transmits to the DVD recorder 1 and to the Blu-ray recorder 2, via the HDMI cables 10 and 20 respectively, a checking command which checks whether or not any antenna 4 is connected (a step S3). To explain this step S3 in more detail, the control unit 13 of the DVD recorder 1, when queried, checks whether or not the antenna 4 is connected to that device 1. This check is made by checking whether or not any video signal is being inputted to the reception unit 14. And the control unit 13 returns the result of this check to the TV 3 via the control line 13A and the HDMI cable 10. In a similar manner, when queried, the control unit of the Blu-ray recorder 2 also checks whether or not the antenna is connected to that device 2, and returns the result of this check to the TV 3 via the HDMI cable 20.

It should be understood that communication related to queries between the control unit 33 and the control units of the DVD recorder 1 and the Blu-ray recorder 2 is performed with a special type of command which is defined in the HDMI-CEC standard.

When the result of this checking is returned, the control unit 33 of the TV 3 makes a decision as to whether or not the antenna 4 is connected to that video recording device which is to execute video recording on the basis of the video recording appointment (a step S4). If the antenna 4 is connected to the video recording device which is to execute video recording on the basis of the video recording appointment, then the control unit 33 transmits the details of the video recording appointment which have been inputted via the HDMI cable 10 to the DVD recorder 1 or, as appropriate, to the Blu-ray recorder 2 (i.e. makes the setting on the corresponding video recording device) (a step S5). And the DVD recorder 1 or the Blu-ray recorder 2 performs video recording on the basis of the details of this video recording appointment.

On the other hand, if the antenna 4 is not connected to the video recording device which is to execute video recording on the basis of the video recording appointment, then the control unit 33 makes a decision as to whether or not a checking command has been transmitted to all of the available recording devices (a step S6). Then the control unit 33 returns to the step S3, and the processing described above is continued.

It should be understood that, since this step S6 is processing which is provided for ensuring that the checking command has not been transmitted erroneously, accordingly, in implementation, this step S6 may be omitted.

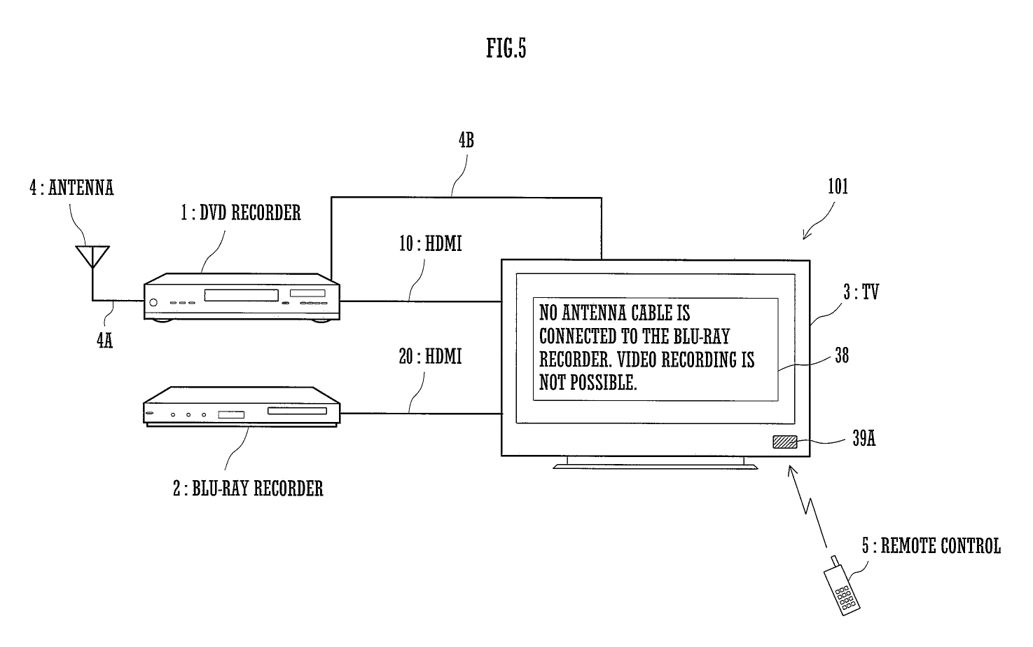

And after the step S6, on the basis of the checking results returned from the connected devices, the control unit 33 commands the video output unit 36 to display upon the TV screen device specification information which specifies that video recording device or devices, among the plurality of video recording devices which are connected, to which the antenna 4 is not connected (a step S7). For example, if the user has set a video recording appointment upon the TV 3 to the effect that video recording is to be performed with the Blu-ray recorder 2, then, if the antenna 4 is not connected to the Blu-ray recorder 2, the message shown in FIG. 5 is displayed as an OSD upon the screen of the TV 3. And the control unit 33 then terminates this processing without accepting the setting for video recording appointment which has been inputted.

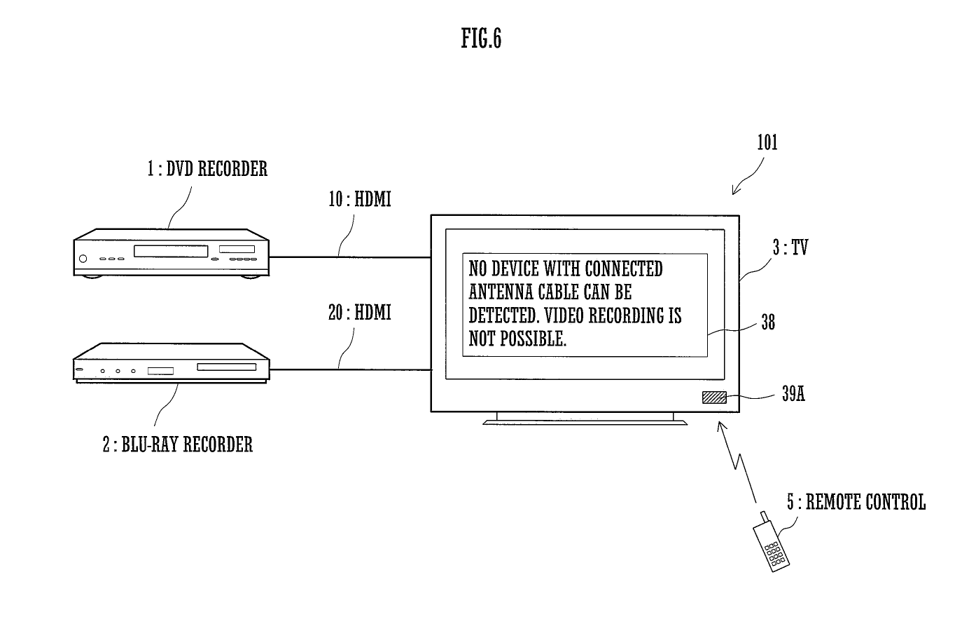

On the other hand, if it is decided in the step S2 that no video recording device is connected, then the control unit 33 displays a message by OSD upon the TV 3 to the effect that no device which is capable of performing video recording is connected (refer to FIG. 6) (a step S8).

By the above, the TV 3 is able to convey device specification information to the user by displaying a message like those shown in FIGS. 5 and 6. By seeing this message, the user is able to ascertain whether or not the antenna 4 is connected to the video recording device with which he wishes to perform video recording. And, if the antenna 4 is not connected to the video recording device with which he wishes to perform video recording, then the user is able to connect the antenna cable 4A to this video recording device. Due to this, it is possible to prevent failure of the video recording on the basis of the video recording appointment in advance, before it even happens. Thus the convenience of use from the point of view of the user can be enhanced.

Furthermore, if the video recording device with which the user desires to perform video recording is not connected to the antenna 4, then, since the setting which has been inputted for the video recording appointment is not accepted, accordingly a situation in which it is not possible to perform video recording although it has been appointed to do so is prevented from occurring, irrespective of the fact that the user has attempted to make such a video recording appointment. Accordingly, it is possible to prevent failure of the video recording on the basis of the video recording appointment in advance, before it even happens. Thus the convenience of use from the point of view of the user can be enhanced by a further level.

It should be understood that the control unit 33 may perform the operations shown in FIG. 4, not only during video recording appointment, but also before the start of video recording (for example, five minutes before). And if, before the start of video recording, based upon these operations shown in FIG. 4, it is found that no antenna is connected to that video recording device which is supposed to perform the video recording on the basis of the video recording appointment, then the control unit 33 may display device specification information upon the screen of the TV 3 (refer to FIGS. 5 and 6). Due to this, before the video recording starts, it is possible to prevent failure of the video recording on the basis of the video recording appointment in advance, before it even happens. Accordingly, the convenience of use from the point of view of the user can be enhanced by yet a further level.

What is claimed is:

1. A video recording appointment system, comprising:
a plurality of video recording devices, each of which records on a medium program data of a television program which is received by an antenna connected to that video recording device; and
a display device which comprises:
a plurality of input ports, each of which is connected to a corresponding one of said plurality of video recording devices via a corresponding bidirectional cable;
a reception means, which receives input of a remote control signal transmitted from a remote control device constituting input of a video recording appointment for any one of said plurality of video recording devices; and
a display means which displays an image upon a screen; and
wherein:
said display device comprises a control means which, when said remote control signal related to said video recording appointment is received by said reception means, queries each of said plurality of video recording devices, via said corresponding cable, as to whether or not said antenna is connected to said video recording device;
each of said plurality of video recording devices comprises a response means which, when said query arrives, checks whether or not said antenna is connected to said video recording device, and returns the result of said checking to said display device via said cable; and
said control means of said display device, on the basis of said check results returned from said response means of said plurality of video recording devices, commands said display means to display device specification information which specifies at least one of said plurality of video recording devices to which said antenna is not connected.

2. A video recording appointment system according to claim 1, wherein:
said bidirectional cables are HDMI cables; and
said control means and said response means perform communication related to said queries with a special type of command defined according to the HDMI-CEC standard.

3. A video recording appointment system according to claim 1, wherein, if a video recording device set in said video recording appointment is specified in said device specification information, said control means rejects said video recording appointment for said video recording device.

4. A video recording appointment system according to claim 1, wherein said control means commands said display means to display said device specification information upon said screen, both during the video recording appointment process and before video recording starts.

5. A video recording appointment system according to claim 1, wherein:
each of said video recording devices is a DVD recorder, a Blu-ray recorder, or a hard disk recorder; and
said device specification information is information which specifies the type of said video recording device.

6. A display device comprising:
a plurality of input ports, each of which is connected via a corresponding one of a plurality of bidirectional cables to a corresponding one of a plurality of video recording devices which video records on a medium program data of a television program which is received by an antenna connected to that video recording device;
a reception means, which receives input of a remote control signal transmitted from a remote control device constituting input of a video recording appointment for any one of said plurality of video recording devices;
a display means which displays an image upon a screen; and
a control means which, when said remote control signal related to said video recording appointment is received by said reception means, queries each of said plurality of video recording devices via said corresponding cable, as to whether or not said antenna is connected to said video recording device; and
wherein said control means, on the basis of said check results returned from said response means of said plurality of video recording devices, commands said display means to display device specification information which specifies those of said plurality of video recording devices to which said antenna is not connected.
